(19) United States
(12) Patent Application Publication
(10) Pub. No.: US 2025/0327897 A1
(43) Pub. Date: Oct. 23, 2025

(54) FREQUENCY MODULATED CONTINUOUS WAVE (FMCW) RADAR SYSTEMS

(71) Applicant: Sensoride Corporation, San Diego, CA (US)

(72) Inventors: Hassan Daniel Moradi, San Diego, CA (US); Ashish Basireddy, San Diego, CA (US)

(73) Assignee: Sensoride Corporation, San Diego, CA (US)

(21) Appl. No.: 19/044,566

(22) Filed: Feb. 3, 2025

Related U.S. Application Data
(60) Provisional application No. 63/635,953, filed on Apr. 18, 2024.

(51) Int. Cl. G01S 7/35

(52) U.S. Cl. CPC G01S 7/356

(57) ABSTRACT

A radar system includes a transmit antenna arranged to transmit a first frequency-modulated continuous-wave (FMCW) pulse and a second FMCW pulse, wherein the second FMCW pulse is subsequent to the first FMCW pulse. A receive antenna is arranged to (1) generate first data in response to receiving a first reflected signal corresponding to the first FMCW pulse, and (2) generate second data in response to receiving a second reflected signal corresponding to the second FMCW pulse. A processor is configured to perform a Fast Fourier Transform (FFT) analysis of the first data and the second data after receiving the first data and the second data.

### CROSS-REFERENCES TO OTHER APPLICATIONS

This application claims priority to U.S. provisional patent application Ser. No. 63/635,953, for “SUBCHIRP WAVEFORM FOR FREQUENCY MODULATED CONTINUOUS WAVE (FMCW) RADAR SYSTEMS” filed on Apr. 18, 2024, which is hereby incorporated by reference in entirety for all purposes.

### FIELD

The described embodiments relate generally to radar systems, such as arrays that employ one or more transmitters and one or more receivers. More particularly, the present embodiments relate to a radar system that employs a plurality of frequency modulated continuous wave (FMCW) pulses in a pulse set to determine information for one or more targets.

### BACKGROUND

Radar sensors in advanced driver assistance systems (ADAS) and automated driving systems (ADS) can improve the safety of operating a vehicle. However, traditional radar transceivers used in these systems have marginal range resolution which can provide false sensing between the automobile and an obstacle. Range resolution represents the smallest separation between two targets that the radar can distinguish. Range resolution is a function of the transmitted waveform and is inversely proportional to the signal bandwidth, which is usually limited in these systems. Further, interfering signals from other environmental sources (e.g., another radar or a jamming device) may compromise current radar systems. Such interference “radar noise” can be an escalating challenge as the number of vehicles on the road that are equipped with radar continues to increase. More particularly, a weak interference between radar systems can degrade sensitivity of radar receivers while a strong interference can lead to more significant issues, such as false targets or, under certain conditions, saturated (effectively blind) radar receivers. An autonomous driving system may fail if a radar receiver of a vehicle becomes effectively blind with regard to detecting a surrounding target or obstacle, potentially having catastrophic results.

New radar systems are needed that have improved range resolution and that are less susceptible to “radar noise” without significantly increasing the cost of the system.

### SUMMARY

In some embodiments a radar system comprises a transmit antenna arranged to transmit a first frequency-modulated continuous-wave (FMCW) pulse and a second FMCW pulse, wherein the second FMCW pulse is subsequent to the first FMCW pulse. A receive antenna is arranged to generate first data in response to receiving a first reflected signal corresponding to the first FMCW pulse and to generate second data in response to receiving a second reflected signal corresponding to the second FMCW pulse. A processor is configured to perform a Fast Fourier Transform (FFT) analysis of the first data and the second data after receiving the first data and the second data.

In some embodiments the second FMCW pulse immediately follows the first FMCW pulse. In various embodiments the receive antenna is a first receive antenna, the radar system further comprising a second receive antenna arranged to generate third data in response to receiving the first reflected signal corresponding to the first FMCW pulse, and to generate fourth data in response to receiving the second reflected signal corresponding to the second FMCW pulse. The processor is configured to perform the Fast Fourier Transform (FFT) analysis of the first data, the second data, the third data and the fourth data after receiving each of the first data, the second data, the third data and the fourth data.

In some embodiments the transmit antenna is a first transmit antenna, the radar system further comprising a second transit antenna arranged to transmit a third (FMCW) pulse and a fourth FMCW pulse, wherein the fourth FMCW pulse is subsequent to the third FMCW pulse. The receive antenna is arranged to generate third data in response to receiving a third reflected signal corresponding to the third FMCW pulse, and generate fourth data in response to receiving a fourth reflected signal corresponding to the fourth FMCW pulse. The FFT analysis is a first FFT analysis and wherein the processor is further configured to perform a second FFT analysis of the third data and the fourth data after receiving the third data and the fourth data.

In some embodiments a sequence of the FMCW pulses is: first FMCW pulse, third FMCW pulse, second FMCW pulse, fourth FMCW pulse. In various embodiments the processor is configured to use both the first FFT analysis and the second FFT analysis to determine information for a target. In some embodiments each of the first and the second FMCW pulses start at a first frequency, transition to a second frequency, then transition back to the first frequency. In some embodiments each of the first and the second FMCW pulses have a same pulse width.

In some embodiments a radar system comprises a first transmit antenna arranged to transmit a first plurality of sequential frequency-modulated continuous-wave (FMCW) pulses, a second transmit antenna arranged to transmit a second plurality of sequential frequency-modulated continuous-wave (FMCW) pulses and a receive antenna arranged to generate a first data set in response to receiving reflected signals corresponding to the first plurality of sequential FMCW pulses and generate a second data set in response to receiving reflected signals corresponding to the second plurality of sequential FMCW pulses. A processor is arranged to analyze the first data set and to analyze the second data set.

In some embodiments the processor is arranged to perform a first fast-Fourier transform (FFT) analysis of the first data set, then perform a second FFT analysis of the second data set. In various embodiments the processor is arranged to perform a peak detection algorithm on results of the first and the second FFT analyses. In some embodiments the receive antenna is a first receive antenna, the radar system further comprising a second receive antenna arranged to generate a third data set in response to receiving reflected signals corresponding to the first plurality of sequential FMCW pulses, and generate a fourth data set in response to receiving reflected signals corresponding to the second plurality of sequential FMCW pulses, wherein the processor is further arranged to analyze the third data set and to analyze the fourth data set.

In some embodiments the processor is arranged to perform a first fast-Fourier transform (FFT) analysis of the first data set, then perform a second FFT analysis of the second data set, then perform a third FFT analysis of the third data set and then perform a fourth FFT analysis of the fourth data set. In various embodiments the processor includes a local system-on-a-chip (SOC) processor proximate the first transmit antenna, the second transmit antenna and the receive antenna and further includes a second processor coupled to the first processor. In some embodiments each of the plurality of first sequential FMCW pulses and each of the plurality of second sequential FMCW pulses start at a same first frequency, transition to a same second frequency, then transition back to the same first frequency. In various embodiments each of the plurality of first sequential FMCW pulses and each of the plurality of second sequential FMCW pulses have a same pulse width.

In some embodiments a method of operating a radar system comprises transmitting sequentially, via a first transmit antenna, a first frequency-modulated continuous-wave (FMCW) pulse and a second FMCW pulse and receiving sequentially, via a receive antenna, a first reflected signal corresponding to the first FMCW pulse and a second reflected signal corresponding to the second FMCW pulse. The method further comprises transmitting sequentially, via a second transmit antenna, a third FMCW pulse and a fourth FMCW pulse and receiving sequentially, via the receive antenna, a third reflected signal corresponding to the third FMCW pulse and a fourth reflected signal corresponding to the fourth FMCW pulse.

In some embodiments the receive antenna is arranged to generate first data in response to receiving the first reflected signal and generate second data in response to receiving the second reflected signal. The method further comprises performing a Fast Fourier Transform (FFT) analysis of the first data and the second data after receiving the first data and the second data. In various embodiments the receive antenna is arranged to generate third data in response to receiving the third reflected signal and generate fourth data in response to receiving the fourth reflected signal. The method further comprises performing a Fast Fourier Transform (FFT) analysis of the third data and the fourth data after receiving the third data and the fourth data. In various embodiments each of the first, second, third and fourth FMCW pulses start at a first frequency, transition to a second frequency, then transition back to the first frequency.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIG. 1A is a simplified diagram of a physical radar system that may use FMCW pulse sets to provide azimuth and/or elevation data for a target, according to embodiments of the disclosure;

FIG. 1B illustrates steps associated with a method of operating the radar system shown in FIG. 1A;

FIG. 1C is a simplified signal diagram of representative transmission signals that can be transmitted by each transmit antenna and corresponding reflected signals that can be received by each receiver of the radar system shown in FIG. 1A;

FIG. 2 is a simplified graph of an example FMCW pulse set, according to embodiments of the disclosure;

FIG. 3 is a simplified graph of an example FMCW pulse set, according to embodiments of the disclosure;

FIG. 4 is a block diagram of an example processor that may be used to operate a radar system, according to embodiments of the disclosure; and

FIG. 5 is a simplified graph of an example pulse-time-share radar scheme where the first transmit antenna and the second transmit antenna have interleaved pulses, according to embodiments of the disclosure.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques disclosed herein relate generally to radar systems. More specifically, techniques disclosed herein relate to radar systems that use a plurality of frequency modulated continuous wave (FMCW) pulses from each transmit antenna arranged in a pulse set. A processor performs a fast-Fourier transform (FFT) analysis of each pulse set to generate target data. As compared to traditional radar systems that only analyze a single pulse from each transmit antenna, the embodiments disclosed herein may provide improved range resolution and/or noise immunity without increasing the bandwidth of the radar system and without significantly increasing the system cost. Various inventive embodiments are described herein, including methods, processes, systems, devices, and the like.

For example, in some embodiments a radar system includes a transmit antenna arranged to transmit a first frequency-modulated continuous-wave (FMCW) pulse and a second FMCW pulse, wherein the second FMCW pulse is subsequent to the first FMCW pulse. The radar system includes a receive antenna arranged to, 1) generate first data in response to receiving a first reflected signal corresponding to the first FMCW pulse, and 2) generate second data in response to receiving a second reflected signal corresponding to the second FMCW pulse. A processor is configured to perform a Fast Fourier Transform (FFT) analysis of the first data and the second data after receiving both the first data and the second data. In some embodiments the second FMCW pulse immediately follows the first FMCW pulse, however in other embodiments the pulses from each transmitter may be interleaved. Each of the FMCW pulses start at a first frequency, transition to a second frequency, then transition back to the first frequency in a repeating pattern. In some embodiments pulse sets can include three, four, five or more pulses. In further embodiments, a radar system may have two, three, four or more receive antennas that each receive reflected signals corresponding to the FMCW pulses.

In order to better appreciate the features and aspects of radar systems that use FMCW pulse sets for improving range resolution and improving noise immunity according to the present disclosure, further context for the disclosure is provided in the following section by discussing one particular implementation of a radar system according to embodiments of the present disclosure. These embodiments are for example only and other embodiments may have different radar layouts, different system architectures and the like.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

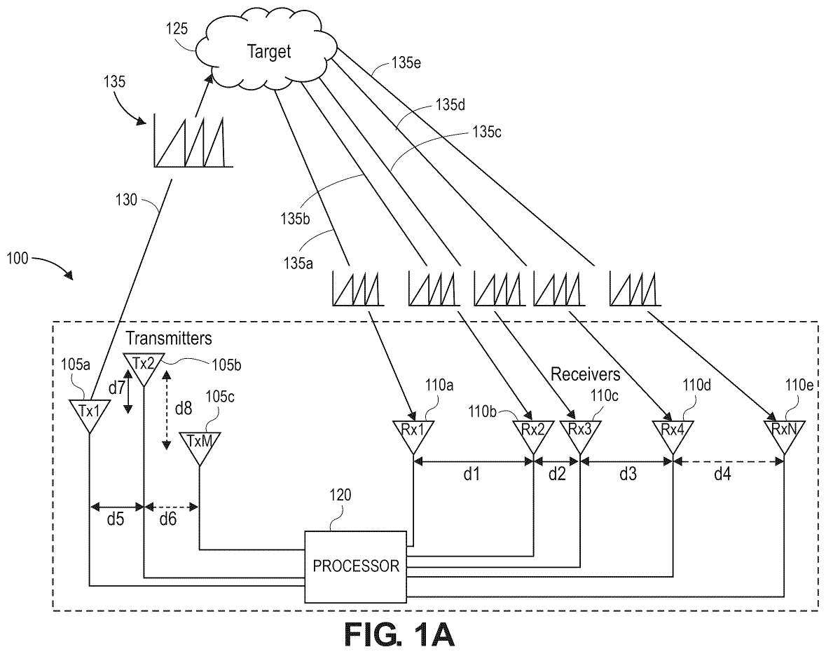

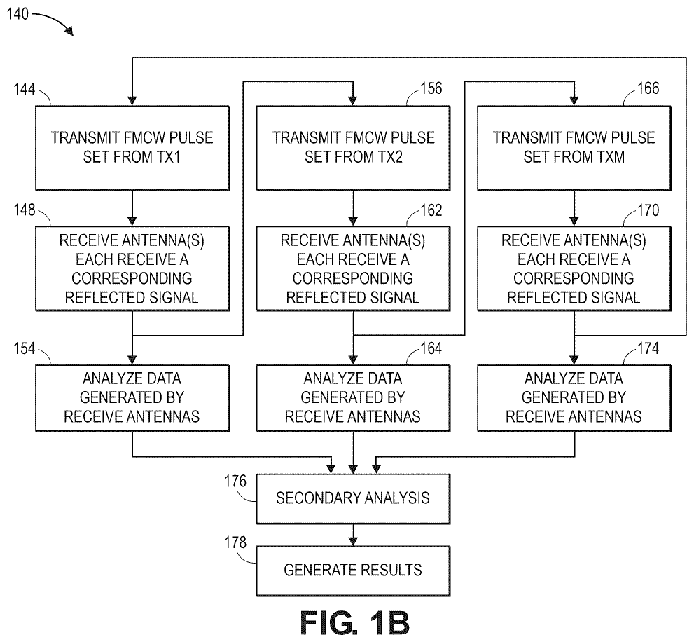

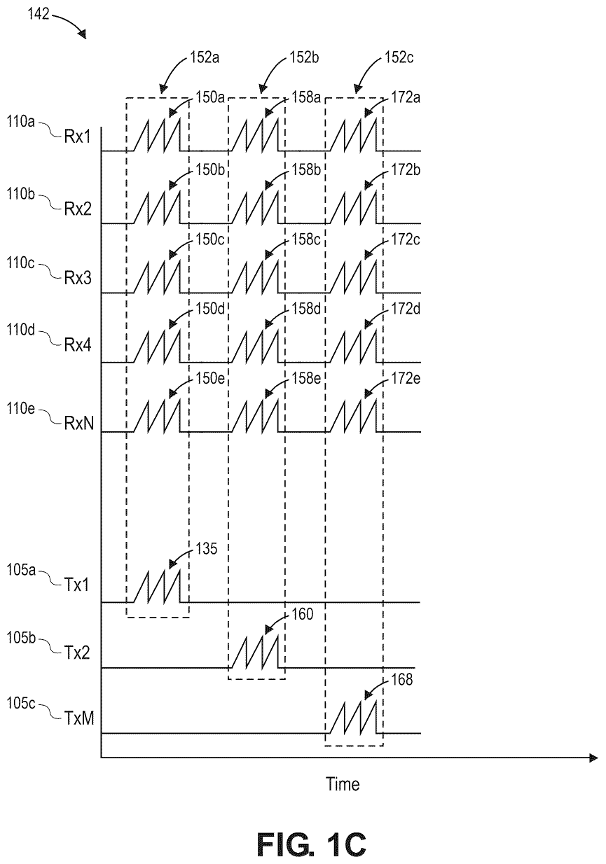

FIG. 1A is a simplified diagram of a physical radar system 100 that may use FMCW pulse sets to provide azimuth and/or elevation data for a target 125, according to some embodiments of the present disclosure. As shown in FIG. 1A, radar system 100 may include three physical transmit antennas 105 where Tx1 105a and Tx2 105b are separated in a horizontal direction by d5 and separated in a vertical direction by d7 and where Tx2 105b and TxM 105c are separated in the horizontal direction by d6 and in the vertical direction by d8. The third physical transmit antenna TxM 105c indicates that the radar system can include M total physical transmit antennas. While M is three in FIG. 1A, M can have any suitable value including but not limited to one, two, four, five or more. Each transmit antenna 105 may be configured to transmit a signal (e.g., signal 130) that includes a FMCW pulse set 133, as described in more detail below.

Radar system 100 also includes five physical receive antennas where Rx1 110a is separated from Rx2 110b by d1, Rx3 110c is separated from Rx2 110b by d2 and Rx4 110d is separated from Rx3 110c by d3. The fifth physical receive antenna RxN 110e is separated from Rx 4 110d by d4 and indicates that the radar system can include N total physical receive antennas. While N is five in FIG. 1A, N can be any suitable value, including M. Each receive antenna 110 may be configured to receive a reflected signal (e.g., reflected signals 135a-135e) that correspond to the transmitted signal (e.g., signal 130), as described in more detail below.

In some embodiments Tx1 105a may transmit a first FMCW pulse set 133, and each receive antenna Rx1 110a. . . . RxN 110e may receive corresponding reflected signals 135a . . . 135e that each have a corresponding number of pulses. Each physical transmit antenna 105 and receive antenna 110 is connected to a processor 120. In some embodiments processor 120 controls each antenna and may more also control the transmission operations of the transmit antennas 105 and/or the received data from the receive antennas 110. In further embodiments, the processor 120 may receive a FMCW pulse set from one or more receive antennas 110, then perform an analysis, such as a FFT of the received data. More particularly, in some embodiments, the processor 120 may wait until all data is received from the transmitted FMCW pulse set before performing analysis on the received signals so the entire “burst” can be analyzed, as explained in more detail below.

As appreciated by one of skill in the art having the benefit of this disclosure, processor 120 may include one or more additional processors which may or may not be collocated with each other. In some embodiments the analysis may be performed by processor 120 while in other embodiments the analysis may be performed by one or more additional processors, as described in more detail below. The processor 120 may be or include any of the components, features, or characteristics of any of the processors described in the present disclosure. Processor 120 may be any suitable processing system including but not limited to a system on a chip (SOC), a local and/or remote computing system or a combination of computing systems. In some embodiments the processor 120 may include a machine learning model that receives data from one or more physical antennas and produces data for one or more virtual receive antennas.

FIG. 1B illustrates steps associated with a method 140 of operating radar system 100, shown in FIG. 1A. FIG. 1C is a simplified signal diagram 142 of representative transmission signals that can be transmitted by each transmit antenna and corresponding reflected signals that can be received by each receiver of radar system 100 shown in FIG. 1A. FIGS. 1B and 1C will be described simultaneously to further illustrate features of the radar system.

In step 144 of method 140 shown in FIG. 1B, transmit antenna Tx1 transmits a first FMCW pulse set. As shown in FIG. 1C a first FMCW pulse set 135 transmitted by Tx1 105a includes three sequential pulses, however any suitable number of pulses including two, four, five or more may be transmitted. The transmitted signal (e.g., signal 130, see FIG. 1A) may be reflected off of the target (125, see FIG. 1A) such that corresponding reflected signals are received by each receive antenna, as described in more detail below.

In step 148 of method 140 shown in FIG. 1B, each receive antenna 110 (e.g., Rx1. . . . RxN, see FIG. 1A) receives a corresponding reflected signal (e.g., signals 135a . . . 135e, see FIG. 1A) that each include a pulse set corresponding to the first FMCW pulse set 135 transmitted by Tx1 105a. As shown in FIG. 1C, receive antenna Rx1 110a receives a corresponding pulse set 150a. Similarly, receive antenna Rx2 110b receives a corresponding pulse set 150b, receive antenna Rx3 110c receives a corresponding pulse set 150c, receive antenna Rx4 110d receives a corresponding pulse set 150d and receive antenna RxN 110e receives a corresponding pulse set 150e. The corresponding pulse sets 150 received by each receive antenna 110 may be referred to as a “burst” (e.g., burst 152) and may be analyzed as a group, as described in more detail below. In other embodiments an individual “frame” that includes one transmitted pulse and a corresponding reflected signal received by one or more receive antennas may be alternatively used for analysis.

Now referring back to method 140 of FIG. 1B, after the receive antennas 110 receive corresponding reflected signals in step 148, the process may proceed in two separate paths where the data generated by the receive antennas is analyzed in step 154 and where Tx2 transmits a second FMCW pulse set in step 156.

In step 154, each receive antenna 110 generates data corresponding to the respective received signals 135 and that data is analyzed. The received data from each of the receive antennas 110 along with the transmit data from transmit antenna Tx1 105a may be called a “burst” 152 (see FIG. 1C) which is analyzed by a processor to determine information for one or more targets. In some embodiments the analysis may include performing a fast-Fourier transform (FFT) of the “burst” and/or performing preprocessing and/or post-processing of the data.

In step 156, second transmit antenna Tx2 150b transmits a FMCW pulse set. As shown in FIG. 1C an example second FMCW pulse set 160 transmitted by Tx2 105b includes three sequential pulses, however any suitable number of pulses including two, four, five or more may be transmitted. The transmitted signal may be reflected off of the target (125, see FIG. 1A) such that corresponding reflected signals are received by each receive antenna 110, as described in more detail below.

In step 162 of method 140 shown in FIG. 1B, each receive antenna 110 (e.g., Rx1 . . . RxN, see FIG. 1A) receives a corresponding reflected signal (e.g., signals 135a . . . 135e, see FIG. 1A) that each include a pulse set corresponding to the second FMCW pulse set 160 transmitted by Tx2 105b. As shown in FIG. 1C, receive antenna Rx1 110a receives a corresponding pulse set 158a. Similarly, receive antenna Rx2 110b receives a corresponding pulse set 158b, receive antenna Rx3 110c receives a corresponding pulse set 158c, receive antenna Rx4 110d receives a corresponding pulse set 158d and receive antenna RxN 110e receives a corresponding pulse set 158e. The corresponding pulse sets received by each receive antenna may be referred to as a “burst” (e.g., burst 152b) and may be analyzed as a group, as described in more detail below. In other embodiments an individual “frame” that includes one transmitted pulse and a corresponding reflected signal received by one or more receive antennas may be alternatively used for analysis.

Now referring back to method 140 of FIG. 1B, after the receive antennas 110 receive signals in step 162, the process may proceed in two separate paths where the data generated by the receive antennas is analyzed in step 164 and where a third transmit antenna TxM 150c transmits a third FMCW pulse set in step 166.

In step 164, each receive antenna 110 generates data corresponding to the respective received signals and that data is analyzed. The received data from each of the receive antennas Rx1 . . . RxN 110 along with the transmit data from transmit antenna Tx2 105b may be called a “burst” 152b (see FIG. 1C) which is analyzed by a processor to determine information for one or more targets. In some embodiments the analysis may include performing a fast-Fourier transform of the “burst” and/or performing preprocessing and/or post-processing of the data.

In step 166, third transmit antenna TxM 105c transmits a third FMCW pulse set. As shown in FIG. 1C a third FMCW pulse set 168 transmitted by TxM 105c includes three sequential pulses, however any suitable number of pulses including two, four, five or more may be transmitted. The transmitted signal may be reflected off of the target (125, see FIG. 1A) such that corresponding reflected signals are received by each receive antenna 110, as described in more detail below.

In step 170 of method 140 shown in FIG. 1B, each receive antenna 110 (e.g., Rx1 . . . RxN, see FIG. 1A) receives a corresponding reflected signal (e.g., signals 135a . . . 135e, see FIG. 1A) that each include a pulse set corresponding to the third FMCW pulse set 168 transmitted by TxM 105c. As shown in FIG. 1C, receive antenna Rx1 110a receives a corresponding pulse set 172a. Similarly, receive antenna Rx2 110b receives a corresponding pulse set 172b, receive antenna Rx3 110c receives a corresponding pulse set 172c, receive antenna Rx4 110d receives a corresponding pulse set 172d and receive antenna RxN 110e receives a corresponding pulse set 172e. The corresponding pulse sets received by each receive antenna 110 may be referred to as a “burst” (e.g., burst 152c) and may be analyzed as a group, as described in more detail below. In other embodiments an individual “frame” that includes one transmitted pulse and a corresponding reflected signal received by one or more receive antennas may be alternatively used for analysis.

Now referring back to method 140 of FIG. 1B, after the receive antennas 110 receive a reflected signal in step 170, the process may proceed in two separate paths where the data generated by the receive antennas 110 is analyzed in step 174 and where the transmit sequence is repeated, returning to step 144 to transmit a new first FMCW pulse set from Tx1 105a.

In step 174, each receive antenna 110 generates data corresponding to the respective received signals and that data is analyzed. The received data from each of the receivers Rx1 . . . RxN 110 along with the transmit data from transmit antenna Tx3 105c may be called a “burst” 152c (see FIG. 1C) which is analyzed by a processor to determine information for one or more targets. In some embodiments the analysis may include performing a fast-Fourier transform of the “burst” and/or performing preprocessing and/or post-processing of the data.

After data from each respective “burst” has been analyzed in each of steps 154, 164 and 174, the method proceeds to step 176 in which a secondary analysis of the data generated in steps 154, 164 and 174 is performed. In some embodiments the output of the FFT analyses performed in steps 154, 164 and 174 is analyzed using a peak detection algorithm and/or a Constant false alarm rate (CFAR) detection algorithm which is an adaptive algorithm used to detect target returns against a background of noise. In other embodiments other suitable analyses may be performed on the data.

In step 178, the results of the secondary analysis performed in step 176 are used to generate results. In some embodiments the results may be a two-dimensional map of the azimuth and elevation position of one or more targets and may include a third dimension of proximity and/or relative signal strength. These and other types and/or configurations of results are within the scope of this disclosure.

It will be appreciated that method 140 is illustrative and that variations and modifications are possible. Steps described as sequential may be executed in parallel, order of steps may be varied, and steps may be modified, combined, added or omitted.

Although each pulse set is described and illustrated in FIG. 1C as including three pulses, each pulse set may include two, four, five, six, seven, eight or more pulses. In some embodiments the number of pulses in each pulse set may be approximately proportional to an increase in range resolution as compared to a radar system that uses a single FMCW pulse. Although each pulse set is described and illustrated in FIG. 1C as having a same width and the same frequency ranges, one or more of the pulses may have different widths, different frequency ranges or other varied parameters.

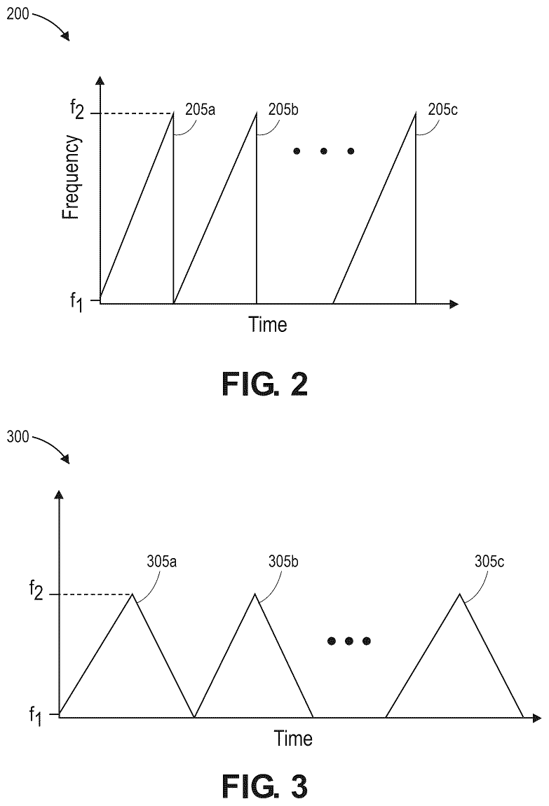

FIG. 2 is a simplified graph of an example FMCW pulse set 200, according to embodiments of the disclosure. FMCW pulse set 200 may be used in any of the radar systems described herein and may include any characteristics of FMCW pulse sets disclosed herein. As shown in FIG. 2, FMCW pulse set 200 includes a first pulse 205a, a second pulse 205b and an nth pulse 205c. Although FMCW pulse set 200 shows a total of three pulses, the pulse set may include any number of pulses including, but not limited to, two, four, five, six or more. Each FMCW pulse 205 can be characterized by a linear rise in frequency with time from a low (first) frequency f₁ to a high (second) frequency f₂ followed by a rapid decrease back to the low (first) frequency f₁. A difference (f₂−f₁) between the high frequency and low frequency can be referred to as bandwidth. In some embodiments one or more of the frequency transitions may not be linear and may be any suitable shape including but not limited to exponential, hyperbolic, curvilinear, piecewise linear, etc.

In traditional single pulse radar systems the bandwidth of a pulse can determine the range resolution of the radar system. For example, in some embodiments the low frequency can have a value of 76 GHZ, the high frequency can have a value of 80 GHZ, and the bandwidth can have a value of 4 GHZ (f₂−f₁=80 GHz−76 GHZ=4 GHZ). As compared to using a single pulse where the range resolution is limited by a bandwidth of the single pulse e.g., 4 GHZ, the use of a plurality of pulses (e.g., FMCW pulse set 200) can provide a significant increase in spatial resolution without requiring increased bandwidth, improving the range resolution approximately proportional to the number of pulses in the pulse set. For example, a pulse set having two pulses can improve the range resolution by a factor of approximately two, a pulse set having three pulses can improve the range resolution by a factor of approximately three, etc.

Generally, the FMCW pulses 205 can be periodic and describe how the radar signal frequency changes over time. In some embodiments each pulse within a pulse set can have a same bandwidth, however in other embodiments one or more of the pulses can have either a same or a different bandwidth and/or different frequency ranges. Further, although each pulse in FIG. 2 is shown as a repeating sawtooth pulse, there can be time delays between one or more pulses and the pulses may have other suitable shapes, some of which are described herein.

As discussed above, another advantage of a radar that employs FMCW pulse sets is improved noise immunity and resistance to jamming. This feature can be illustrated with regard to FIG. 2. As an example, interference can occur when an adjacent automobile or a jammer emits a radar signal at a same frequency as one of the FMCW pulses 205 (e.g., both transmitters are transmitting for a brief moment at the same frequency). This will saturate the receiver at that frequency and at that particular time, however in a FMCW pulse set architecture, only one pulse in the pulse set is likely affected as the overlap time in frequency will be extremely short. The analysis algorithm can easily disregard the outlier pulse and can still analyze the remaining pulses which can be used to generate data for the target. In contrast, in a single-pulse radar system, the entire pulse must be discarded so the radar system will not have any data for that cycle. If the interference is repeated at a different frequency, the single pulse system will still not be able to report data on the target while the FMCW pulse set will be able to report data. Therefore, an FMCW pulse set radar system has improved noise immunity and jamming resistance as compared to a traditional single-pulse radar system.

FIG. 3 is a simplified graph of another example FMCW pulse set 300, according to embodiments of the disclosure. FMCW pulse set 300 may be used in any of the radar systems described herein and may include any characteristics of FMCW pulse sets disclosed herein. As shown in FIG. 3, FMCW pulse set 300 includes a first pulse 305a, a second pulse 305b and an nth pulse 305c. Although FMCW pulse set 300 shows a total of three pulses, the pulse set may include any number of pulses including, but not limited to, two, four, five, six or more. Each pulse 305 can be characterized by a linear rise in frequency with time from a low (first) frequency f₁ to a high (second) frequency f₂ followed by a linear decrease back to the low (first) frequency f₁. A difference (f₂−f₁) between the high frequency and low frequency can be referred to as bandwidth. In some embodiments one or more of the frequency transitions may not be linear and may be any suitable shape including but not limited to exponential, hyperbolic, curvilinear, piecewise linear, etc. In some embodiments each pulse within a pulse set can have a same bandwidth, however in other embodiments one or more of the pulses can have either a same or a different bandwidth and/or different frequency ranges.

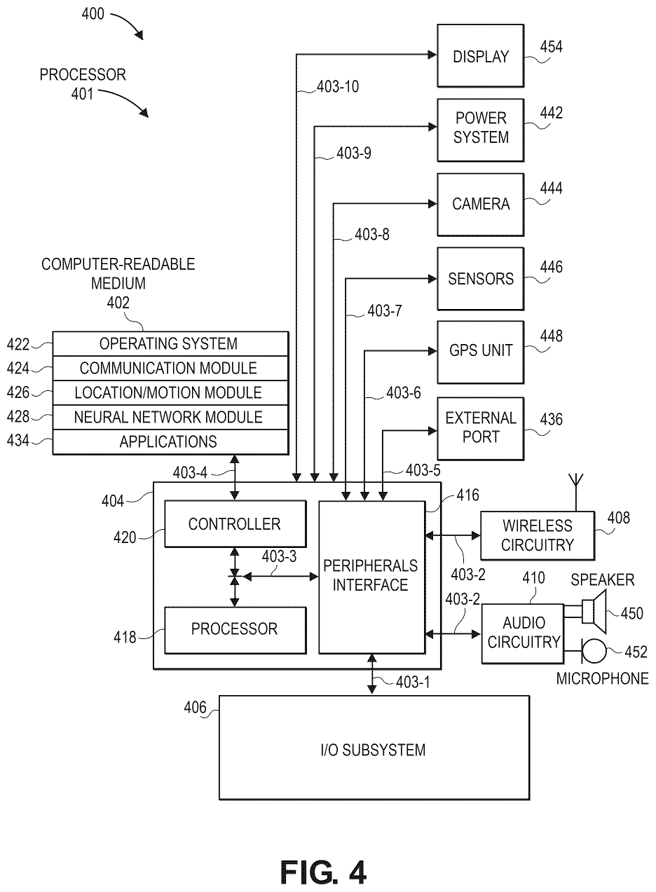

FIG. 4 is a block diagram 400 of an example processor 401 that may be used to operate a radar system (e.g., radar system 100) as described in any of the embodiments herein that can transmit, receive, and evaluate radar signals formed with a FMCW pulse set configuration, according to embodiments of the disclosure. For example, processor 401 may be used as processor 120 in FIG. 1, or as a processor that performs one or more of the analysis steps and/or generation of results steps in FIG. 1B, or that performs any other function related to the radar systems and processes described herein. Processor 401 may be one or more semiconductor devices including but not limited to a system on a chip (SOC), a multi-chip module, a field programmable gate array (FPGA) or other suitable device. In some embodiments, processor 401 may include a computer-readable medium (memory) 402, a processing system 404, an Input/Output (I/O) subsystem 406, wireless circuitry 408, and audio circuitry 410 including speaker 450 and microphone 452. These components may be coupled by one or more communication buses or signal lines 403. Processor 401 can encompass any suitable processing device and/or portable electronic device, including a handheld computer, a tablet computer, a remote control unit for a drone, a mobile phone, laptop computer, tablet device, media player, a wearable device, personal digital assistant (PDA), a multi-function device, a mobile phone, a portable gaming device, a car display unit, or the like, including a combination of two or more of these items.

The processor 401 can be a multifunction device having a touch screen in accordance with some embodiments. The touch screen optionally displays one or more graphics within user interface (UI). In some embodiments, a user is enabled to select one or more of the graphics by making a gesture on the graphics, for example, with one or more fingers or one or more styluses. In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with processor 401. In some implementations or circumstances, inadvertent contact with a graphic does not select the graphic. For example, a swipe gesture that sweeps over an application icon optionally does not select the corresponding application when the gesture corresponding to selection is a tap. Processor 401 can optionally also include one or more physical buttons, such as “home” or menu button. As menu button is, optionally, used to navigate to any application in a set of applications that are, optionally executed on the processor 401. Alternatively, in some embodiments, the menu button is implemented as a soft key in a graphical user interface displayed on touch screen.

The processor 401 can incorporate a display 454. The display 454 can be a LCD, OLED, AMOLED, Super AMOLED, TFT, IPS, or TFT-LCD that typically can be found a computing device. The display 454 may be a touch screen display of a computing device.

In one embodiment, processor 401 includes touch screen, menu button, push button for powering the device on/off and locking the device, volume adjustment button(s), Subscriber Identity Module (SIM) card slot, head set jack, and docking/charging external port. Push button is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, processor 401 also accepts verbal input for activation or deactivation of some functions through microphone. Processor 401 also, optionally, includes one or more contact intensity sensors for detecting intensity of contacts on touch screen and/or one or more tactile output generators for generating tactile outputs for a user of processor 401.

In one illustrative configuration, processor 401 may include at least one computer-readable medium (memory) 402 and one or more processing units (or processor(s)) 418. Processor(s) 418 may be implemented as appropriate in hardware, software, or combinations thereof. Computer-executable instruction or firmware implementations of processor(s) 418 may include computer-executable instructions written in any suitable programming language to perform the various functions described.

Computer-readable medium (memory) 402 may store program instructions that are loadable and executable on processor(s) 418, as well as data generated during the execution of these programs. Depending on the configuration and type of processor 401, memory 402 may be volatile (such as random access memory (RAM)) and/or non-volatile (such as read-only memory (ROM), flash memory, etc.). Processor 401 can have one or more memories. Processor 401 may also include additional removable storage and/or non-removable storage including, but not limited to, magnetic storage, optical disks, and/or tape storage. The disk drives and their associated non-transitory computer-readable media may provide non-volatile storage of computer-readable instructions, data structures, program modules, and other data for the devices. In some implementations, memory 402 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

Memory 402 and additional storage, both removable and non-removable, are all examples of non-transitory computer-readable storage media. For example, non-transitory computer readable storage media may include volatile or non-volatile, removable or non-removable media implemented in any method or technology for storage of information such as computer-readable instructions, data structures, program modules, or other data. Memory 402 and additional storage are both examples of non-transitory computer storage media. Additional types of computer storage media that may be present in processor 401 may include, but are not limited to, phase-change RAM (PRAM), SRAM, DRAM, RAM, ROM, electrically erasable programmable read-only memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by processor 401. Combinations of any of the above should also be included within the scope of non-transitory computer-readable storage media. Based on the disclosure and teachings provided herein, a person of ordinary skill in the art can appreciate other ways and/or methods to implement the various embodiments. However, as noted above, computer-readable storage media does not include transitory media such as carrier waves or the like.

Alternatively, computer-readable communication media may include computer-readable instructions, program modules, or other data transmitted within a data signal, such as a carrier wave, or other transmission. However, as used herein, computer-readable storage media does not include computer-readable communication media.

Processor 401 may also contain communications connection(s) 408 that allow processor 401 to communicate with a data store, another device or server, user terminals and/or other devices via one or more networks. Such networks may include any one or a combination of many different types of networks, such as cable networks, the Internet, wireless networks, cellular networks, satellite networks, other private and/or public networks, or any combination thereof. Processor 401 may also include I/O device(s) 406, such as a touch input device, a keyboard, a mouse, a pen, a voice input device, a display, a speaker, a printer, etc.

It should be apparent that the architecture shown in FIG. 4 is only one example of an architecture for processor 401, and that processor 401 can have more or fewer components than shown, or a different configuration of components. The various components shown in FIG. 4 can be implemented in hardware, software, or a combination of both hardware and software, including one or more signal processing and/or application specific integrated circuits.

Wireless circuitry 408 is used to send and receive information over a wireless link or network to one or more other devices' conventional circuitry such as an antenna system, an RF transceiver, one or more amplifiers, a tuner, one or more oscillators, a digital signal processor, a CODEC chipset, memory, etc. Wireless circuitry 408 can use various protocols, e.g., as described herein. For example, wireless circuitry 408 can have one component for one wireless protocol (e.g., Bluetooth®) and a separate component for another wireless protocol (e.g., UWB). Different antennas can be used for the different protocols.

Wireless circuitry 408 is coupled to processing system 404 via peripherals interface 416. Interface 416 can include conventional components for establishing and maintaining communication between peripherals and processing system 404. Voice and data information received by wireless circuitry 408 (e.g., in speech recognition or voice command applications) is sent to one or more processors 418 via peripherals interface 416. One or more processors 418 are configurable to process various data formats for one or more application programs 434 stored on computer-readable medium (memory) 402.

Peripherals interface 416 couple the input and output peripherals of the device to processor(s) 418 and computer-readable medium 402. One or more processors 418 communicate with computer-readable medium 402 via a controller 420. Computer-readable medium 402 can be any device or medium that can store code and/or data for use by one or more processors 418. Medium 402 can include a memory hierarchy, including cache, main memory, and secondary memory.

Processor 401 also includes a power system 442 for powering the various hardware components. Power system 442 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management, and distribution of power in mobile devices.

In some embodiments, processor 401 includes a camera 444. In some embodiments, processor 401 includes sensors 446. Sensors 446 can include accelerometers, compasses, gyrometers, pressure sensors, audio sensors, light sensors, barometers, and the like. Sensors 446 can be used to sense location aspects, such as auditory or light signatures of a location.

In some embodiments, processor 401 can include a GPS receiver, sometimes referred to as a GPS unit 448. A mobile device can use a satellite navigation system, such as the Global Positioning System (GPS), to obtain position information, timing information, altitude, or other navigation information, including for one or more objects detected by the radar system. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 418 run various software components stored in medium 402 to perform various functions for processor 401. In some embodiments, the software components include an operating system 422, a communication module (or set of instructions) 424, a location module (or set of instructions) 426, a fast-Foureier transform and neural network module 428 that is used as part of signal analysis operation described herein, and other applications (or set of instructions) 434.

Operating system 422 can be any suitable operating system, including iOS, Mac OS, Darwin, RTXC, LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components. An operating system 422 is system software that manages computer hardware and software resources and provides common services for computer programs. For example, the operating system 422 can manage the interaction between the user interface module and one or more user application(s). The various embodiments further can be implemented in a wide variety of operating environments, which in some cases can include one or more user computers, devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network.

Communication module 424 facilitates communication with other devices over one or more external ports 436 or via wireless circuitry 408 and includes various software components for handling data received from wireless circuitry 408 and/or external port 436. External port 436 (e.g., USB, FireWire, Lightning connector, 60-pin connector, etc.) is adapted for coupling directly to other devices or indirectly over a network (e.g., the Internet, wireless LAN, etc.).

Location/motion module 426 can assist in determining the current position (e.g., coordinates or other geographic location identifiers) and motion of processor 401 and/or one or more objects detected by the radar system. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 426 receives data from GPS unit 448 and analyzes the signals to determine the current position of the mobile device and or a target detected by the radar system. In some embodiments, location/motion module 426 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 408 and is passed to location/motion module 426. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for processor 401 based on the position coordinates of the corresponding transmitters. Regardless of the specific location technology used, location/motion module 426 receives information from which a location fix can be derived, interprets that information, and returns location information, such as geographic coordinates, latitude/longitude, or other location fix data.

The neural network and FFT module 428 can be employed with sparse antennas and used to transform the radar system from a discrete-time signal to a continuous-time signal within the network architecture. In some embodiments the network may be based on a Tensorflow Processing Units (TPU) approach that utilizes sparse antennas in conjunction with the neural network. In some embodiments a neural network can be trained based on generative machine learning generative model based on other based on perception, including Deep Neural Networks (DNN) and convolutional neural network (CNN). In some embodiments the neural network may undergo training to understand patterns and correlations within the available radar data, enabling the network to estimate the signals for the extrapolated antennas that are missing in the array. This module may also perform peak detection and/or CFAR analysis.

The one or more applications programs 434 on the mobile device can include any applications installed on the processor 401, including without limitation, a browser, address book, contact list, email, instant messaging, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating, and displaying graphical objects (including without limitation text, web pages, icons, digital images, animations and the like) on a display surface. In another example, a timer module can be a software timer. The timer module can also be implemented in hardware. The time module can maintain various timers for any number of events.

The I/O subsystem 406 can be coupled to a display system (not shown), which can be a touch-sensitive display. The display system displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 406 can include a display and user input devices such as a keyboard, mouse, and/or track pad. In some embodiments, I/O subsystem 406 can include a touch-sensitive display. A touch-sensitive display can also accept input from the user based on haptic and/or tactile contact. In some embodiments, a touch-sensitive display forms a touch-sensitive surface that accepts user input. The touch-sensitive display/surface (along with any associated modules and/or sets of instructions in medium 402) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, the I/O subsystem can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, processor 401 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art can appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Most embodiments utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a network server, the network server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more applications that may be implemented as one or more scripts or programs written in any programming language, such as Java®, C, C # or C++, or any scripting language, such as Perl, Python or TCL, as well as combinations thereof. The server(s) may also include database servers, including without limitation those commercially available from Oracle®, Microsoft®, Sybase®, and IBM®.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen or keypad), and at least one output device (e.g., a display device, printer, or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically can include a number of software applications, modules, services or other elements located within at least one working memory device, including an operating system and application programs, such as a client application or browser. It should be appreciated that alternate embodiments may have numerous variations from that described above. For example, customized hardware might also be used and/or particular elements might be implemented in hardware, software (including portable software, such as applets) or both. Further, connection to other devices such as network input/output devices may be employed.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g., a solid state drive, a hard drive, a CD, or an entire computer system), and may be present on or within different computer products within a system or network. A computer system may include a monitor, printer, or other suitable display for providing any of the results mentioned herein to a user.

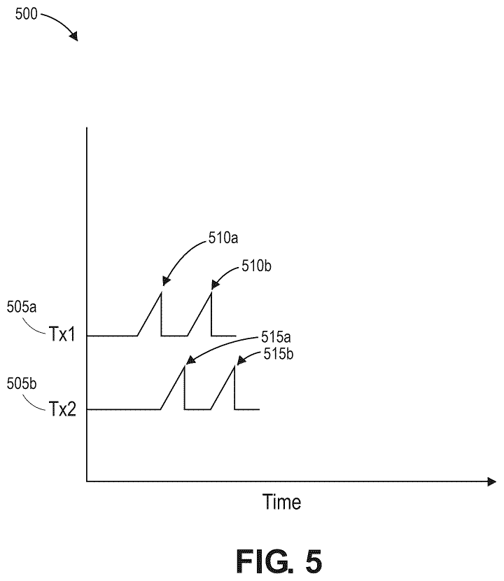

FIG. 5 is a simplified graph of an example pulse-time-share radar scheme 500 where the first transmit antenna Tx1 505a and the second transmit antenna Tx2 505b have interleaved pulses, according to embodiments of the disclosure. The pulse-time-share transmission scheme 500 can be used in any of the radar systems disclosed herein. As shown in FIG. 5, a first transmit antenna Tx1 505a can transmit a first pulse 510a. A second transmit antenna Tx2 505b can transmit a sequential second pulse 515a. The first transmit antenna Tx1 505a, transmits the third sequential pulse 510b and then the second transmit antenna Tx2 505b, transmits the fourth sequential pulse 515b. Each of the pulses 510, 515 are received by each of the receive antennas (e.g., 110 in FIG. 1A). However, in pulse-time-share scheme each receive antenna 110 may have a data buffer associated with it such that e.g., a first receive antenna will collect pulses corresponding to the first transmit antenna Tx1 505a in a first buffer and will collect pulses corresponding to the second transmit antenna Tx2 505b in a second buffer. Once a respective buffer has received a complete pulse set such that a complete burst can be constructed (e.g., the first buffer has received all pulse sets transmitted by Tx1 and the second buffer has received all pulse sets transmitted by Tx2), the burst will be analyzed as further described in FIG. 1B.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A radar system comprising:
a transmit antenna arranged to transmit a first frequency-modulated continuous-wave (FMCW) pulse and a second FMCW pulse, wherein the second FMCW pulse is subsequent to the first FMCW pulse;
a receive antenna arranged to:
generate first data in response to receiving a first reflected signal corresponding to the first FMCW pulse; and
generate second data in response to receiving a second reflected signal corresponding to the second FMCW pulse; and
a processor configured to perform a Fast Fourier Transform (FFT) analysis of the first data and the second data after receiving the first data and the second data.

2. The radar system of claim 1, wherein the second FMCW pulse immediately follows the first FMCW pulse.

3. The radar system of claim 1, wherein the receive antenna is a first receive antenna, the radar system further comprising a second receive antenna arranged to:
generate third data in response to receiving the first reflected signal corresponding to the first FMCW pulse; and
generate fourth data in response to receiving the second reflected signal corresponding to the second FMCW pulse; and
wherein the processor is configured to perform the Fast Fourier Transform (FFT) analysis of the first data, the second data, the third data and the fourth data after receiving each of the first data, the second data, the third data and the fourth data.

4. The radar system of claim 1, wherein the transmit antenna is a first transmit antenna, the radar system further comprising a second transit antenna arranged to transmit a third (FMCW) pulse and a fourth FMCW pulse, wherein the fourth FMCW pulse is subsequent to the third FMCW pulse;
wherein the receive antenna is arranged to:
generate third data in response to receiving a third reflected signal corresponding to the third FMCW pulse; and
generate fourth data in response to receiving a fourth reflected signal corresponding to the fourth FMCW pulse; and
wherein the FFT analysis is a first FFT analysis and wherein the processor is further configured to perform a second FFT analysis of the third data and the fourth data after receiving the third data and the fourth data.

5. The radar system of claim 4 wherein a sequence of the FMCW pulses is: first FMCW pulse, third FMCW pulse, second FMCW pulse, fourth FMCW pulse.

6. The radar system of claim 4 wherein the processor is configured to use both the first FFT analysis and the second FFT analysis to determine information for a target.

7. The radar system of claim 1, wherein each of the first and the second FMCW pulses start at a first frequency, transition to a second frequency, then transition back to the first frequency.

8. The radar system of claim 1, wherein each of the first and the second FMCW pulses have a same pulse width.

9. A radar system comprising:
a first transmit antenna arranged to transmit a first plurality of sequential frequency-modulated continuous-wave (FMCW) pulses;
a second transmit antenna arranged to transmit a second plurality of sequential frequency-modulated continuous-wave (FMCW) pulses;
a receive antenna arranged to:
generate a first data set in response to receiving reflected signals corresponding to the first plurality of sequential FMCW pulses; and
generate a second data set in response to receiving reflected signals corresponding to the second plurality of sequential FMCW pulses; and
a processor arranged to analyze the first data set and to analyze the second data set.

10. The radar system of claim 9, wherein the processor is arranged to perform a first fast-Fourier transform (FFT) analysis of the first data set, then perform a second FFT analysis of the second data set.

11. The radar system of claim 10, wherein the processor is arranged to perform a peak detection algorithm on results of the first and the second FFT analyses.

12. The radar system of claim 9, wherein the receive antenna is a first receive antenna, the radar system further comprising a second receive antenna arranged to:
generate a third data set in response to receiving reflected signals corresponding to the first plurality of sequential FMCW pulses; and
generate a fourth data set in response to receiving reflected signals corresponding to the second plurality of sequential FMCW pulses; and
wherein the processor is further arranged to analyze the third data set and to analyze the fourth data set.

13. The radar system of claim 12, wherein the processor is arranged to perform a first fast-Fourier transform (FFT) analysis of the first data set, then perform a second FFT analysis of the second data set, then perform a third FFT analysis of the third data set and then perform a fourth FFT analysis of the fourth data set.

14. The radar system of claim 9, wherein the processor includes a local system-on-a-chip (SOC) processor proximate the first transmit antenna, the second transmit antenna and the receive antenna and further includes a second processor coupled to the first processor.

15. The radar system of claim 9, wherein each of the plurality of first sequential FMCW pulses and each of the plurality of second sequential FMCW pulses start at a same first frequency, transition to a same second frequency, then transition back to the same first frequency.

16. The radar system of claim 9, wherein each of the plurality of first sequential FMCW pulses and each of the plurality of second sequential FMCW pulses have a same pulse width.

17. A method of operating a radar system, the method comprising:
transmitting sequentially, via a first transmit antenna, a first frequency-modulated continuous-wave (FMCW) pulse and a second FMCW pulse;
receiving sequentially, via a receive antenna, a first reflected signal corresponding to the first FMCW pulse and a second reflected signal corresponding to the second FMCW pulse;
transmitting sequentially, via a second transmit antenna, a third FMCW pulse and a fourth FMCW pulse;
receiving sequentially, via the receive antenna, a third reflected signal corresponding to the third FMCW pulse and a fourth reflected signal corresponding to the fourth FMCW pulse.

18. The method of claim 17, wherein the receive antenna is arranged to:
generate first data in response to receiving the first reflected signal; and
generate second data in response to receiving the second reflected signal;
the method further comprising, performing a Fast Fourier Transform (FFT) analysis of the first data and the second data after receiving the first data and the second data.

19. The method of claim 17, wherein the receive antenna is arranged to:
generate third data in response to receiving the third reflected signal; and
generate fourth data in response to receiving the fourth reflected signal;
the method further comprising, performing a Fast Fourier Transform (FFT) analysis of the third data and the fourth data after receiving the third data and the fourth data.

20. The method of claim 17, wherein each of the first, second, third and fourth FMCW pulses start at a first frequency, transition to a second frequency, then transition back to the first frequency.
